(19) United States
(12) Patent Application Publication
(10) Pub. No.: US 2020/0090262 A1
(43) Pub. Date: Mar. 19, 2020

(54) COMPUTING SYSTEMS AND METHODS FOR TRACKING FINANCIAL DEPOSITS AND INTEREST

(71) Applicant: THE BANK OF NOVA SCOTIA, Toronto (CA)

(72) Inventors: Ahmad DAJANI, Toronto (CA); Rahim PREMJI, Toronto (CA); Yaniv NATHAN, Toronto (CA)

(73) Assignees: THE BANK OF NOVA SCOTIA, Toronto, ON (CA); THE BANK OF NOVA SCOTIA, Toronto, ON (CA)

(21) Appl. No.: 16/618,244

(22) PCT Filed: Jun. 8, 2018
(86) PCT No.: PCT/CA2018/000115

§ 371 Date: Nov. 29, 2019

Related U.S. Application Data
(60) Provisional application No. 62/517,652, filed on Jun. 9, 2017.

(51) Int. Cl. G06Q 40/02; G06Q 40/00

(52) U.S. Cl. CPC G06Q 40/02; G06Q 40/125

(57) ABSTRACT

A computing system for tracking financial deposits and interest earned by financial deposits that may include a server having a storage device, the server may be configured to communicate with client computing devices by way of a network. A database may be stored on said storage device. The database may include a first table defining one or more master accounts and one or more paired commitment periods and commitment period accounts corresponding to said master accounts; and a second table comprising interest fields corresponding to each of said commitment period accounts, for tracking contingent interest accrued by said commitment period accounts; a processor at said server, configured under control of software to: periodically compute a contingent interest amount for each said commitment period account and increment the corresponding interest field by said contingent interest amount; and in response to completion of one of said commitment periods, increment the value of the paired commitment period account by a contingent interest value stored in the corresponding interest field.

### CROSS-REFERENCE TO RELATED APPLICATIONS

This application claims priority to U.S. Patent Application No. 62/517,652, filed on Jun. 9, 2018, the contents of which are hereby incorporated by reference in their entirety.

### FIELD

This relates to financial deposit systems and methods and in particular, for tracking and differential interest treatment of financial deposits.

### BACKGROUND

Many types of savings products exist, and provide a variety of rates of return. Such products include conventional savings accounts to bonds, GICs and the like. Products such as bonds and GICs define fixed maturity periods.

On the other hand, products such as conventional savings accounts allow for easy access to deposited funds, but typically pay very low interest rates. Existing savings account infrastructure allows for only rudimentary processing of deposits. Within accounts, all deposits typically contribute to a single balance and are paid interest at a single low rate.

More complex processing of deposits would allow for new types of savings products.

### SUMMARY

According to one broad aspect there is provided a computing system for tracking financial deposits and interest earned by financial deposits that may include a server having a storage device, the server may be configured to communicate with client computing devices by way of a network. A database may be stored on said storage device. The database may include a first table defining one or more master accounts and one or more paired commitment periods and commitment period accounts corresponding to said master accounts; and a second table comprising interest fields corresponding to each of said commitment period accounts, for tracking contingent interest accrued by said commitment period accounts; a processor at said server, configured under control of software to: periodically compute a contingent interest amount for each said commitment period account and increment the corresponding interest field by said contingent interest amount; and in response to completion of one of said commitment periods, increment the value of the paired commitment period account by a contingent interest value stored in the corresponding interest field.

According to a broad aspect of the invention, the computing system may include a processor which is configured under control of software to periodically compute a base interest amount for each said commitment period account and increment said commitment period account by said base interest amount.

According to another broad aspect of the invention, a database defines a concordance between a plurality of possible commitment period lengths and corresponding contingent interest rates.

According to another broad aspect of the invention, a third table may be included having a plurality of age category fields corresponding to each of said commitment period accounts, each age category field containing an aggregate value of deposits within a particular time period; and a fourth table having a plurality of age category interest fields, corresponding to each of said age category fields, for tracking contingent interest accrued by said commitment period accounts.

According to another broad aspect of the invention, the age category fields may correspond to said commitment period lengths.

A to another broad aspect of the invention, the first table may include an account age value for each of said commitment period accounts and, in response to receiving a deposit instruction for one of said commitment period accounts from a client device over said network, said processor may be configured under control of software to retrieve said account age value and said commitment period, determine a remaining duration of said commitment period, select one of said age category fields corresponding to said remaining duration; and increment the commitment period account and the selected age category field based on said deposit instruction.

According to another broad aspect of the invention, a web server in communication with said server may be included, said web server for retrieving data from said server over said network and presenting the retrieved data in an interface at a client computing device.

According to another broad aspect of the invention, the retrieved data may include said possible commitment period lengths, and wherein said presenting the retrieved data in an interface comprises a prompt for a selection of a commitment period length.

According to another broad aspect of the invention, the retrieved data may include balances of said commitment period accounts and said presenting the retrieved data in an interface comprises presenting a total of said balances as a master account balance.

### BRIEF DESCRIPTION OF DRAWINGS

In the figures, which depict example embodiments:

FIG. 1 is a schematic diagram of a financial deposits system;

FIG. 2 is a block diagram of a server of the system of claim 1;

FIG. 3 is a block diagram of software at the server of FIG. 2;

FIGS. 4A-4B are example tables of a database at the server of FIG. 2;

FIGS. 5A-5B are example tables of a database at the server of FIG. 2;

FIG. 6 is another example table of a database at the server of FIG. 2;

FIGS. 7A-7B are representative account information interface screens presented on a client computing device of the system of FIG. 1;

FIGS. 8A-8E are representative account creation interface screens presented on a client computing device of the system of FIG. 1;

FIG. 9 is a flow chart depicting a process of handling deposit instructions at the server of FIG. 2; and

FIG. 10 is a flow chart depicting a process of computing interest at the server of FIG. 2.

### DETAILED DESCRIPTION

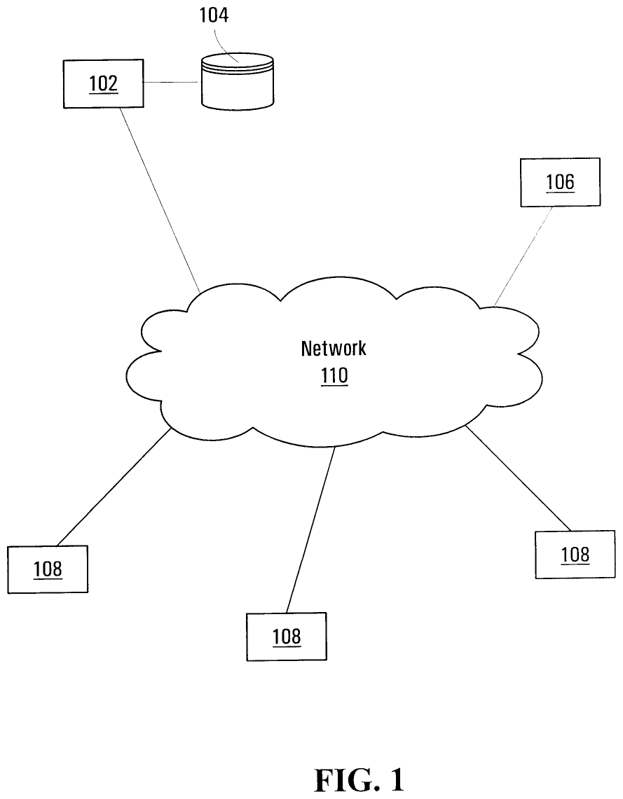

FIG. 1 depicts an example computing system. Components of computing system are interconnected to define a financial deposits system 100. As used herein, the term financial deposits system refers to a combination of hardware devices configured under control of software, and interconnections between such devices and software.

Financial deposits system 100 includes at least one account server 102 with a data storage 104 such as a hard drive, array of hard drives, network-accessible storage or the like; at least one web server 106 and a plurality of client computing devices 108. Account server 102, web server 106 and client computing devices 108 are in communication with by way of a network 110.

The network 110 may include one or more local-area networks or wide-area networks, such as IPv4, IPv6, X.25, IPX compliant or similar networks, including one or more wired or wireless access points. The networks may include one or more local-area networks (LANs) or wide-area networks (WANs), such as the internet. In some embodiments, the networks are connected with other communications networks, such as GSM/GPRS/3G/4G/LTE networks

As shown, account server 102 and web server 106 are separate machines, which may be at different physical or geographical locations. However, account server 102 and web server 106 may alternatively be implemented in a single physical device.

As will be described in further detail, account server 102 a database in data storage 104, including financial deposit account records. Web server 106 hosts a website accessible by client computing devices 108. Web server 106 is further operable to exchange data with account server 102 such that account data can be retrieved from account server 102 and displayed on the website, or entered by way of the website and transmitted to account server 102 for storage.

Account server 102 and web server 106 may be based on Microsoft Windows, Linux or other suitable server operating systems.

Client computing devices 108 may be, for example personal computers, smartphones, tablet computers, or the like, and may be based on any suitable operating system, such as Microsoft Windows, Apple OS X or iOS, Linux, Android, or the like.

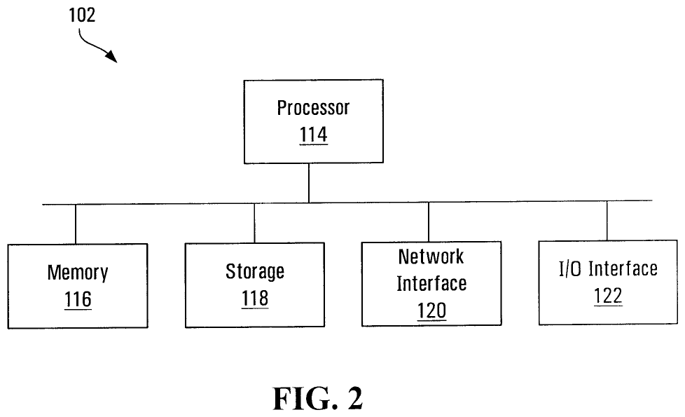

FIG. 2 is a block diagram of components of an example server 102, 106 or client computing device 108. As depicted, each server 102, 106 and client computing device 108 includes a processor 114, memory 116, persistent storage 118, network interface 120 and input/output interface 122.

Processor 114 may be an Intel or AMD x86 or x64, PowerPC, ARM processor, or the like. Processor 114 may operate under control of software loaded in memory 116. Network interface 120 connects server 102, 106 or client computing device 108 to network 110. I/O interface 122 connects server 102, 106 or client computing device 108 to one or more storage devices (e.g. storage 104) and peripherals such as keyboards, mice, USB devices, disc drives, and the like.

Software may be loaded onto server 102, 106 or client computing device 108 from peripheral devices or from network 106. Such software may be executed using processor 114.

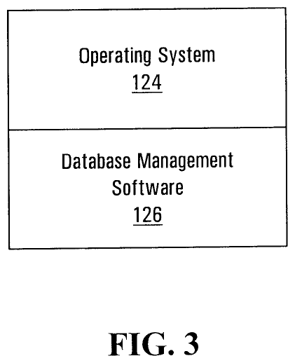

FIG. 3 depicts a simplified arrangement of software at a server 102. The software may include an operating system 124 and application software, such as database management system 126. Database management system may be a system configured for compatibility with the relational database model using a language such as SQL.

Typical financial account databases include identifying values such as account numbers, and account data such as balance. Interest is computed periodically based on the balance.

Unfortunately, such systems do not allow for differential treatment of deposits within a particular account. That is, a single interest rate and calculation are applied to the full balance of an account at each interest period.

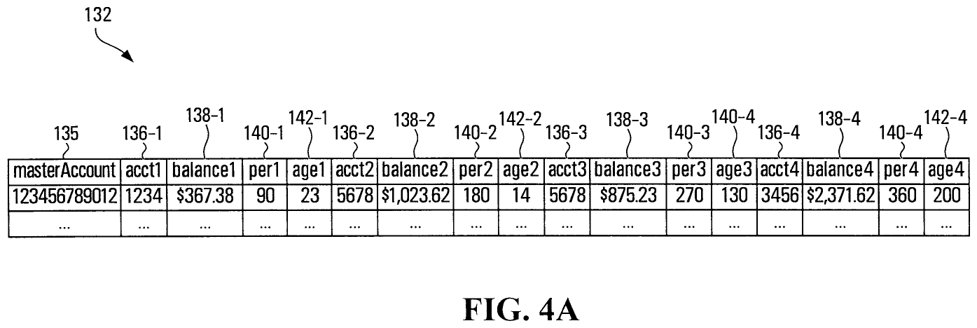

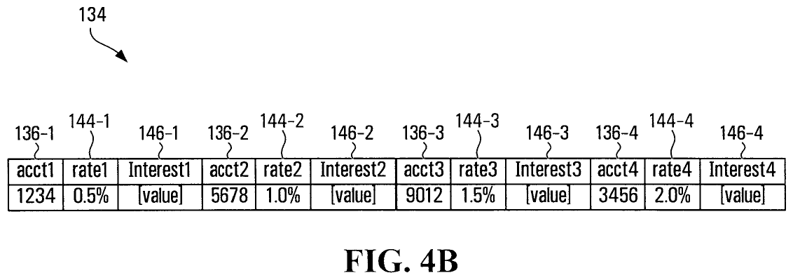

FIGS. 4A-4B depict example tables 132, 134 of a database 130 maintained in storage 104. Database 130 is designed to permit more complex processing of interest for accounts therein. As shown, database 130 is a relational database comprising tables with fields in columnar format. As used herein, references to columns or rows of database 130 may relate to columns or rows of tables within database 130. References herein to performing operations (e.g. ordering, sorting, distributing) based on a column mean performing those operations based on values of a field stored in that column.

Database 130 is structured to permit tracking of subsets of deposits in each account. Calculations, such as interest rate calculations, may be performed differently on each subset.

Specifically, database 130 and tables 132, 134 are structured to permit computation of interest at different rates for different deposits. In examples, increased interest rates are provided to deposits which depositors commit to save, i.e., agree not to withdraw, for set periods of time. The set periods may be referred to as savings periods or commitment periods. The increased interest varies with the length of the commitment periods—longer commitment periods are given higher interest rates. Commitments may be defined by opening commitment accounts, also referred to as savings accounts, within an overarching master deposit account.

Although deposits within different commitment accounts are treated separately for interest purposes, in examples, database 130 and the interface provided by web server 106 are structured so that a depositor can view and access the total aggregate value of deposits within the master account.

Thus, in some embodiments, the structure of database 130 permits financial deposits system 100 to be configured to incentivize depositors to make deposits and save them for extended periods of time.

Moreover, in examples, deposits within the commitment accounts may be further separated and awarded interest based on the remaining length of time for which a deposit is committed to be saved.

As shown, table 132 includes a master account identifier field 135. Each master account 135 includes one or more sub-accounts 136. In the depicted embodiment, master account 135 includes sub-accounts 136-1, 136-2, 136-3, 136-4, with respective balance fields 138-1, 138-2, 138-3, 138-4 (individually and collectively, balance fields 138); deposit category fields 140-1, 140-2, 140-3, 140-4 (individually and collectively, deposit categories 140); and deposit age fields 142-1, 142-2, 142-3, 142-4 (individually and collectively, deposit age fields 142). Each deposit category field 140 and each deposit age field 142 corresponds to a balance field 138. As depicted, table 132 includes four sets of balance fields, deposit category fields and deposit age fields. However, any number of sets may be present.

In the depicted embodiment, each balance field 138 corresponds to a commitment period. That is, for each balance field 138, the corresponding deposit category 140 defines a period of time during which the depositor commits not to withdraw the deposits. Deposit category field 140-1 defines a 90 day period, indicating that deposits recorded in field 138-1 are not to be withdrawn for at least 90 days. Similarly, deposit category fields 140-2, 140-3, 140-4 indicate that deposits recorded in fields 138-2, 138-3, 138-4 are not to be withdrawn for 180, 270 and 360 days, respectively.

Deposit age fields 142 reflect the duration for which deposits have been left in each balance field 138, e.g, the number of days since the first deposit was recorded in each balance field. For example, deposit age field 142-1 indicates that balance field 138-1 is 23 days old. Deposit age fields 142-2 142-3, 142-4 indicate that balance fields 138-2, 138-3, 138-4 are 14, 130 and 200 days old, respectively.

FIG. 4B depicts a table 134 of database 130 used for calculating interest earned on deposits in each balance field 138. Table 134 includes rate fields 144-1, 144-2, 144-3, 144-4 containing interest rates corresponding to commitment accounts 136-1, 136-2, 136-3, 136-4, respectively, and interest fields 146-1, 146-2, 146-3, 146-4 containing accrued interest amounts corresponding to commitment accounts 136-1, 136-2, 136-3, 136-4, respectively.

Database 130 may define a base interest rate, namely a minimum rate applicable to all deposits. In addition, in the depicted embodiment, deposits of different categories earn interest at different rates. For example, the base rate may be 0.5%; monthly deposits may earn interest at 0.75%; 90-day deposits may earn interest at 1%; 180 day deposits may earn interest at 1.5%; 270-day deposits may earn interest at 2.0%; and 360 day deposits may earn interest at 2.5%. Interest rates vary depending on the length of time for which the depositor commits not to withdraw. Specifically, committing a deposit for a period of time the longer the committed time, the higher the interest rate. Thus, the configuration of database 130 allows for variable interest rates to be used to incentivize and reward depositors for making long-term deposits.

Interest rates are stored in rate fields 144. Alternatively or additionally, interest rates may be stored in a separate table of database 130. In the depicted example, rates are stored as marginal differences from the base rate. That is, a rate of 1% for 90-day deposits may be stored as 0.5%, indicating a value 0.5% above the base rate.

In the depicted embodiment, interest is accrued and compounded on a periodic (e.g. daily) basis. Interest accrued at the base rate is added to balance field 138. Interest at higher rates, associated with committed savings periods (referred to as “contingent interest”), is continuously accrued and compounded, but is only added to the balance of an account when the deposit age field 142 reaches the commitment threshold defined in deposit category field 144. Contingent interest is tracked by incrementing the value of the appropriate interest field 146.

Table 132 provides the ability to track deposits into accounts with associated committed savings periods. Accounts may be provided for a number of discrete periods, namely, 90, 180, 270 and 360 days. When depositing funds, a depositor may choose a period of time during which the funds will be saved, without making any withdrawal. Upon making such a commitment, the depositor may be rewarded with elevated interest payments.

In some embodiments, database 130 may allow for further segmentation of deposits. For example, deposits may be made to an account at more than one time. A depositor may make an initial deposit with a commitment period of 360 days, and may wish to make a further deposit at a later time. Database 130 may be configured to track the age of specific deposits within the 360-day account. Thus, the depositor can make an additional deposit into the account and be awarded elevated interest corresponding to the remaining length of the 360 day commitment period.

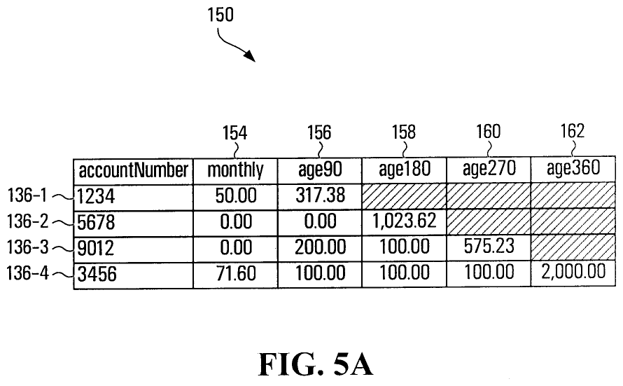

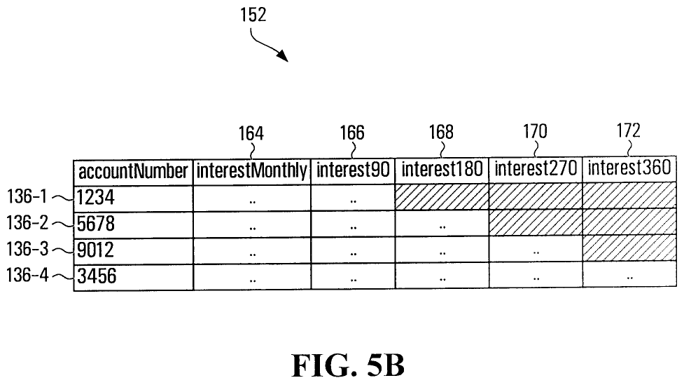

FIGS. 5A-5B depict example tables 150, 152 representative of such an embodiment.

Table 150 contains a breakdown of deposits made into each account 136-1, 136-2, 136-3, 136-4 of master account 135. Specifically, table 150 contains a record corresponding to each account 136 and has category fields 154, 156, 158, 160, 162 corresponding to the available commitment period lengths of monthly, 90, 180, 270 and 360 days. The value in each category field for a given account record contains a total of deposits to that account in the corresponding period. That is, for account record 136-4, with an initial commitment period of 360 days, 360 day field 162 contains a total of deposits made more than 270 days before the end of the period. 270 day field 160 contains a total of deposits made more than 180 days, but no more than 270 days before the end of the period. 180 day field 158 contains a total of deposits made more than 90, but no more than 180 days before the end of the period. 90 day field 156 contains a total of deposits made more than one month, but no more than 90 days before the end of the period, and 30 day field 154 contains a total of deposits made no more than one month before the end of the period. Category fields 154, 156, 158, 160, 162 in a particular account record may be null for categories longer than the commitment period for that account For example, 180 day, 270 day and 360 day fields 158, 160, 162 are null for 90-day account 136-1.

FIG. 5B depicts an example table 152 for tracking contingent interest for amounts in fields 154, 156, 158, 160, 162. Rows of table 152 correspond to accounts 136-1, 136-2, 136-3, 136-4. Rows have a monthly interest field 164; a 90-day field 166; a 180 day field 168; a 270 day field 170; and a 360 day field 172, for tracking interest accrued by amounts in monthly field 154; 90 day field 156; 180 day field 158; 270 day field 160; and 360 day field 162 of table 150, respectively.

Specifically, at each interest period, interest is calculated at the base rate based on the full balance 138 in each account 136 (FIG. 4A). Contingent interest is calculated on the amounts in tables 150, 152. For example, interest is calculated at the monthly rate on the total amount in monthly field 154 and monthly interest field 164. Monthly interest field 164 is incremented by the resulting amount. Likewise, interest is calculated at the 90 day rate based on 90 day field 156 and 90 day interest field 166; interest is calculated at the 180 day rate based on 180 day field 158 and 180 day interest field 168; interest is calculated at the 270 day rate based on 270 day field 160 and 270 day interest field 170; and interest is calculated at the 360 day rate based on 360 day field 162 and 360 day interest field 172. Interest fields 166, 168, 170, 172 are incremented by the respective calculated interest values.

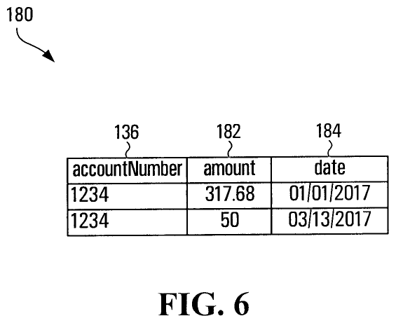

Alternatively or additionally, database 130 may include a log of deposits to each account 136. FIG. 6 depicts an example log 180. As shown, each record of the log identifies an account 136, a deposit amount 182 and a date 184 of the deposit. Contingent interest may be computed and recorded in table 154 by aggregating deposit values in each time period. For example, contingent interest at the 360 day rate may be calculated by retrieving the aggregate value of deposits made more than 270 days before the end of the commitment period and applying the 360 day rate to the result.

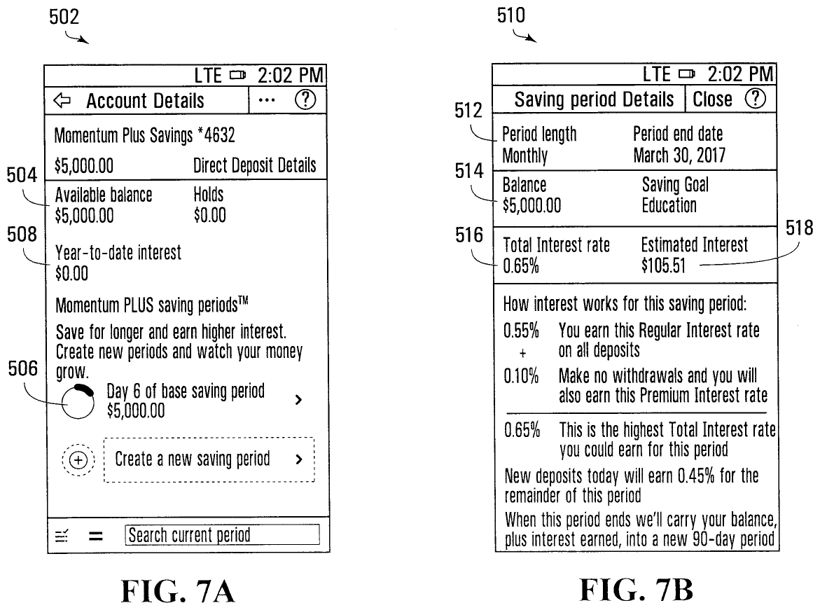

FIGS. 7A-7C depict an example interface presented at a client device 108 by web server 106.

FIG. 7A depicts an account summary 502, rendered on a display of client device 108. The account summary includes a master account balance 504, one or more commitment period indicia 506 and a master interest indicator 508. In the depicted example, master account balance 504 displays the total available balance in all of all commitment accounts 136. That is, the master account balance 504 equals the total of balance fields 138. Similarly, master interest indicator 508 presents the total of all interest accrued, namely base interest posted to accounts 136, and contingent interest tracked in tables 134 or 152 but not yet posted to accounts 136. Commitment account indicia 506 provide a visual indicator of each commitment account 136 that exists in table 132.

FIG. 7B depicts a commitment account summary 510 rendered on a display of a client device 108. Commitment account summary 510 includes a commitment period indicator 512; a commitment account balance 514; a contingent interest rate 516; and at least one interest indicator 518. Commitment period indicator 512 displays the period defined in field 140 of table 132 (FIG. 4A). Commitment balance indicator 514 displays the value recorded in the corresponding balance field 138. Contingent interest rate 516 displays the total interest rate applicable to the relevant commitment period, namely, the sum of the base interest rate and the elevated interest rate recorded in field 144 of table 134. In an example, interest indicator 518 displays an estimate of the interest that will be earned during the commitment period. Additionally or alternatively, interest indicator 518 may display a total interest accrued to date in the commitment account 136, namely, a total of the base interest applied to the account and the interest tracked in tables 134 or 152 but not yet posted to the account 136.

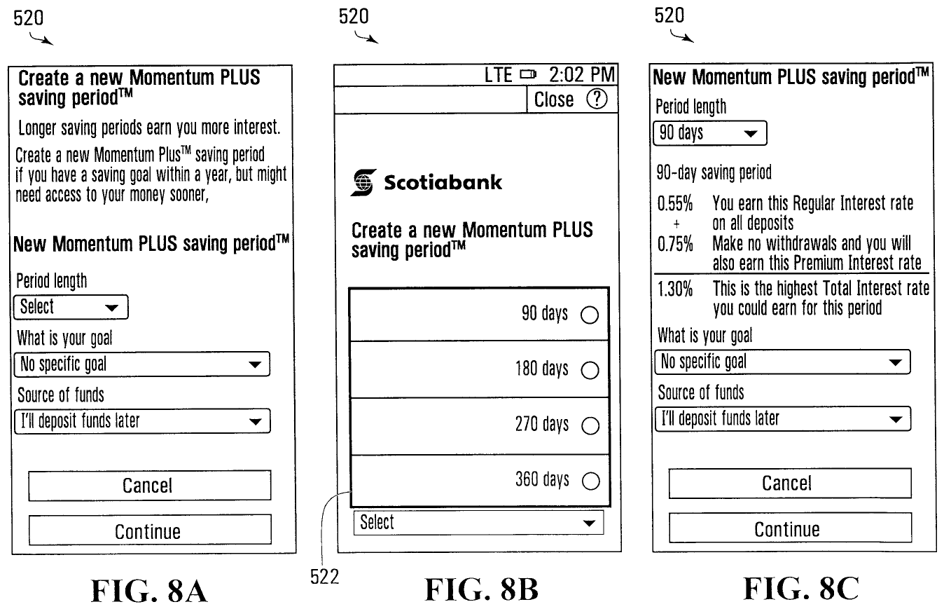

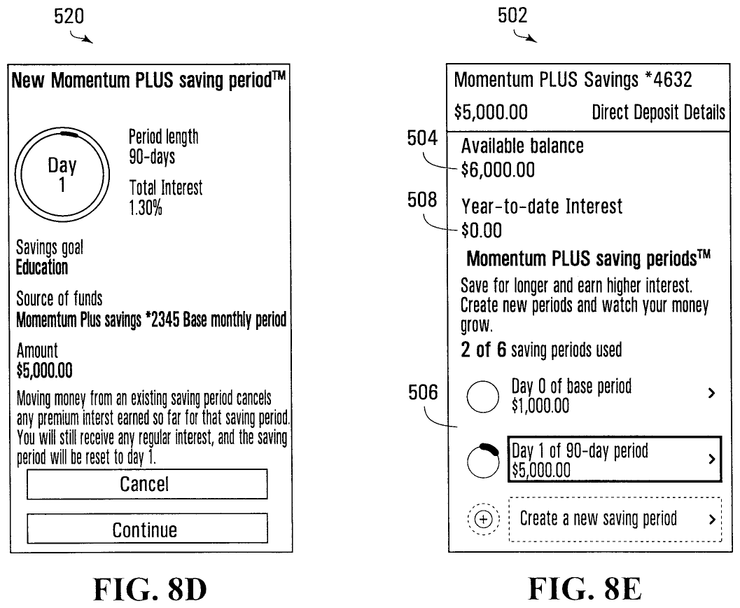

FIGS. 8A-8D depict commitment period intialization screens 520 rendered on a display of a client device at creation of a commitment account 136. During creation of a commitment account 136, initialization screens 520 present a dialog 522 prompting a choice among the available commitment periods, i.e. the possible values available for field 144 of table 132 (FIG. 4A). As shown in FIG. 8D, after creation of a commitment account 136, commitment account indicia 506 of account summary 502 is updated to reflect the added account 136.

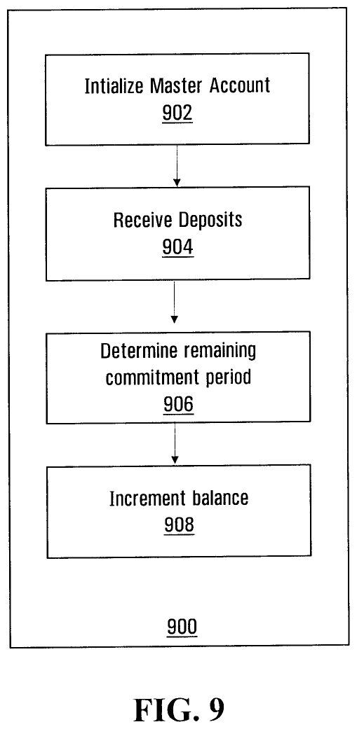

FIG. 9 depicts a process 900 of processing a deposit in database 130.

At block 902, a commitment account 136 is created within a master account 135. Specifically, the commitment account 136 is created by a user accessing web server 106 using a client device 108. The web server 106 causes an interface to be rendered on the display of the client device. As shown in FIGS. 7A-7B and 8A-8E, As part of initializing commitment account 136, the user is prompted to select a commitment period from among the possible values of category field 144 (FIG. 4A).

At block 904, one or more deposits are made into the commitment account 136. Deposits are made by a user accessing web server 106 using a client device 108 and web server 106 causing an interface to be rendered, allowing selection of an amount to be deposited and a commitment account into which a deposit is to be made. A message is sent to server 104 with parameters identifying at least the target account into which the deposit is to be made; the amount of the deposit; and the date of the deposit.

At block 906, database management software 126 at server 104 interprets the message and determines the amount of time remaining in the commitment period, by lookup of age field 142 and period field 140 in table 132. Based on the amount of time remaining, at block 908, database management software 126 identifies the corresponding category in table 150 and increments the relevant field accordingly.

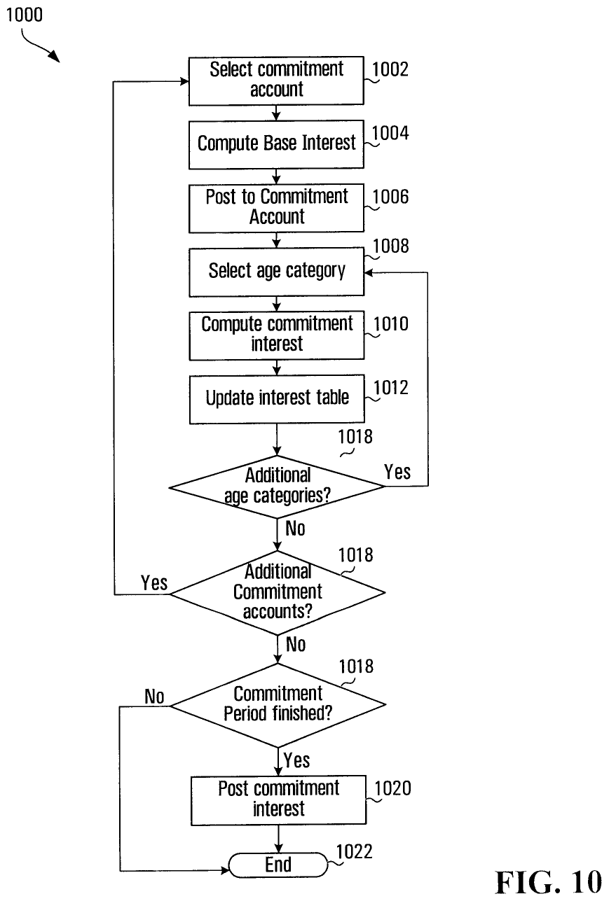

FIG. 10 depicts a process 1000 of tracking interest in database 130. Interest is calculated on the deposited amounts periodically. In an example, interest is calculated daily. However, other frequencies are possible.

At block 1002, a commitment account 136 is selected.

At block 1004, base interest is calculated. Database management software 126 retrieves the balance of the selected commitment account 136 from the corresponding balance field 138. The base interest rate is retrieved from database 130. Base interest for the commitment account 136 is calculated as the product of the base interest rate and the value in balance field 138.

At block 1006, the account balance is updated. Database management software 126 updates table 132 by incrementing the balance field 138 by the interest computed at block 906.

At block 1008, an age category (monthly category 154; 90-day category 156; 180 day category 158; 270 day category 160; or 360 day category 162) within commitment account 136 is selected from table 150. For example, for a 360 day commitment account, deposits within the 360 day category may be selected.

At block 1010, contingent interest is computed. Database management software 126 retrieves the elevated interest rate for the selected age category from database 130 (e.g. from rate fields 144). Database management software 126 further retrieves the balance of the corresponding category from table 150 (FIG. 5A) and the balances of the corresponding interest field (monthly interest field 164; 90-day interest field 166; 180 day interest field 168; 270 day interest field 170; or 360 day interest field 172) from table 152 (FIG. 5B). Contingent interest is calculated as the product of each respective elevated interest rate and the sum of the corresponding category balance and interest.

At block 1012, interest table 152 is updated. Database management software 126 updates table 152 by incrementing the value of the interest field corresponding to the selected age category (monthly interest field 164; 90-day interest field 166; 180 day interest field 168; 270 day interest field 170; or 360 day interest field 172) with the contingent interest computed at block 910.

At block 1014, database management software 126 determines if additional age categories remain within the selected commitment account 136. If so, the process returns to block 910 and repeats for the next category. For example, in a 360 day deposit account, after completion of the 360 day age category, the calculation process may repeat for the 270-day category, if any deposits fall within that category. Other age categories may follow in turn. If no age categories remain for calculation, the process proceeds to block 1008.

At block 1016, database management software 126 determines if additional commitment accounts 136 require interest calculation. If so, the process returns to block 1002 and the process repeats with the next commitment account.

At block 1018, database management software 126 determines if any commitment period is finished, i.e. if no days remain in any commitment period. If so, the process proceeds to block 1020. The sum of interest values stored in table 152 corresponding to the completed commitment period are added to the respective balance value 138 of table 132.

Process 1000 concludes at block 1022 after calculation is performed for every commitment account 136. Thereafter, process 1000 repeats at the next interest period.

If a withdrawal is made from a commitment account 136 at any time during a commitment period, the corresponding contingent interest values in tables 133, 152 are reset to zero and the age value in table 132 is reset to zero. In other words, if a deposit is made prior to completion of a commitment period, the accrued contingent interest is forfeited.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

The following discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be at least partly in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

Although specific embodiments have been described in detail, it should be understood that various changes, substitutions and alterations can be made. The invention is therefore defined by the claims.

What is claimed is:

1. A computing system for tracking financial deposits and interest earned by financial deposits, comprising:
a server having a storage device, said server configured to communicate with client computing devices by way of a network;
a database stored on said storage device, said database comprising:
a first table defining one or more master accounts and one or more paired commitment periods and commitment period accounts corresponding to said master accounts; and
a second table comprising interest fields corresponding to each of said commitment period accounts, for tracking contingent interest accrued by said commitment period accounts;
a processor at said server, configured under control of software to:
periodically compute a contingent interest amount for each said commitment period account and increment the corresponding interest field by said contingent interest amount; and
in response to completion of one of said commitment periods, increment the value of the paired commitment period account by a contingent interest value stored in the corresponding interest field.

2. The computing system of claim 1, wherein said processor is configured under control of software to periodically compute a base interest amount for each said commitment period account and increment said commitment period account by said base interest amount.

3. The computing system of claim 2, wherein said database defines a concordance between a plurality of possible commitment period lengths and corresponding contingent interest rates.

4. The computing system of claim 3, comprising:
a third table having a plurality of age category fields corresponding to each of said commitment period accounts, each age category field containing an aggregate value of deposits within a particular time period;
a fourth table having a plurality of age category interest fields, corresponding to each of said age category fields, for tracking contingent interest accrued by said commitment period accounts.

5. The computing system of claim 4, wherein said age category fields correspond to said commitment period lengths.

6. The computing system of claim 5, wherein said first table comprises an account age value for each of said commitment period accounts and, in response to receiving a deposit instruction for one of said commitment period accounts from a client device over said network, said processor is configured under control of software to:
retrieve said account age value and said commitment period ;
determine a remaining duration of said commitment period;
select one of said age category fields corresponding to said remaining duration; and
increment the commitment period account and the selected age category field based on said deposit instruction.

7. The computing system of claim 6, further comprising a web server in communication with said server, said web server for retrieving data from said server over said network and presenting the retrieved data in an interface at a client computing device.

8. The computing system of claim 7, wherein said retrieved data comprises said possible commitment period lengths, and wherein said presenting the retrieved data in an interface comprises a prompt for a selection of a commitment period length.

9. The computing system of claim 7, wherein said retrieved data comprises balances of said commitment period accounts and said presenting the retrieved data in an interface comprises presenting a total of said balances as a master account balance.
